(19) United States
(12) Patent Application Publication
(10) Pub. No.: US 2002/0085165 A1
(43) Pub. Date: Jul. 4, 2002

(54) Method of forming liquid crystal alignment film and method of producing liquid crystal display device

(76) Inventors: Hirohide Fukumoto, Kagoshima (JP); Hiromi Fukumori, Miyazaki (JP); Shuichi Shima, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/925,667

(22) Filed: Aug. 9, 2001

(30) Foreign Application Priority Data
Aug. 11, 2000 (JP) P2000-244594

(51) Int. Cl. G02F 1/13

(52) U.S. Cl. 349/187

(57) ABSTRACT

A method of forming a liquid crystal alignment film able to prevent uneven drying of a liquid crystal alignment film and thereby prevent alignment defects of the liquid crystal and reduce the defect rate of liquid crystal display devices, including the steps of dissolving a polymer material (preferably a polyimide) in a solvent comprised of a polar main solvent (preferably γ-butyrolactone or N-methyl-α-pyrrolidone) plus about 5 to 15 wt % of butyl β-hydroxyethyl ether as a leveling agent and coating the solution on a substrate; pre-baking the substrate to volatilize at least part of the mixed solvent; and baking the substrate at a higher temperature than pre-baking to polymerize the polymer material, and a method of producing a liquid crystal display device including the above steps.

### BACKGROUND OF THE INVENTION

1. Field of the Invention

The present invention relates to a method of forming a liquid crystal alignment film and a method of producing a liquid crystal display device, in particular a method of forming a liquid crystal alignment film able to align liquid crystal molecules at a certain pretilt angle and a method of producing a liquid crystal display device able to eliminate pixel defects due to unevenness of the pretilt angle.

2. Description of the Related Art

In a liquid crystal display device, the display is realized using the anisotropy of the dielectric constant of the liquid crystal molecules and changing the orientation of the liquid crystal molecules by voltage. For the purpose of controlling the liquid crystal molecules to an orientation and tilt (pretilt angle) suitable for an operation mode of a liquid crystal display device, a liquid crystal alignment film is used.

FIG. 1 is a flow chart showing main production steps of a liquid crystal display device. For forming a liquid crystal display device, first, as shown in FIG. 1, electrodes and semiconductor elements are formed on a substrate. Next, a liquid crystal alignment film is coated on the substrate. The liquid crystal alignment film is baked, then the liquid crystal alignment film is rubbed. After this, a pair of substrates are stacked and a liquid crystal material is sealed between the substrates, whereby liquid crystal molecules are arranged on the liquid crystal alignment film.

Generally, a polyimide, polyamide, or other material is used as the liquid crystal alignment film. Especially, a polyimide has the following characteristics required for a liquid crystal alignment film: (1) a high heat resistance (300° C.); (2) transparency and a high glass transition temperature T_{g}; (3) an affinity with liquid crystal, an ease of alignment of liquid crystal, and non-reactivity with liquid crystal; (4) high bondability with the substrate and electrodes; and (5) simple alignment treatment. Therefore, as a polymer material of a liquid crystal alignment film, a polyimide is used predominantly. Below, a liquid crystal alignment film using a polyimide will be explained.

A polyimide is obtained by heat polymerization of polyamic acid (polyimide acid) at 250° C. or a higher temperature. However, there are limits to the heat resistance of other parts of a liquid crystal display device such as a color filter formed on a semiconductor element, so a liquid crystal alignment film is often formed by coating and baking a soluble polyimide prepared by imidazation of polyamic acid and dissolved in a solvent. In this case, it is possible to bake a polyimide film at up to 180° C.

For the coating solution of the liquid crystal alignment film, for solubilizing the imide component, for example γ-butyrolactone, N-methyl-α-pyrrolidone (NMP), or another polar solvent is used as a main solvent. Further, for improving the coating characteristics and leveling characteristics after coating, butyl β-hydroxyethyl ether (butyl cellosolve, brandname of Union Carbide Corp.) or another solvent is added. The coating solution may be prepared by dissolving a soluble polyimide in such a mixed solvent. Previously, since the leveling characteristics are regarded as important, a coating solution having a composition containing butyl β-hydroxyethyl ether at 20 wt % or a higher concentration is used.

A coating solution of a liquid crystal alignment film is coated by a printing method using a roll coater on a substrate to a thickness of for example about 50 to 100 nm. Figure.2 is a schematic view of a roll coater for coating a liquid crystal alignment film. As shown in FIG. 2, a substrate 1 is conveyed carried on a table 2. A coating solution is supplied from a dispenser 3 to an anilox roller 4. The coating solution supplied to the anilox roller 4 is transferred to a plate cylinder 5 to a uniform thickness. Then, the coating solution is coated uniformly on the substrate 1 by the plate cylinder 5.

The surface of the anilox roller 4 is engraved. The thickness of the coating film changes depend on the number of engraved lines and the depth or shape of the engraving. The thickness of the coating film is also controlled by a supply rate of the coating solution from the dispenser 3 or adjustment of pressure between the anilox roller 4 and plate cylinder 5.

After coating the liquid crystal alignment film, as shown in FIG. 3, the substrate 1 is conveyed to a hot plate 6 and the coating film 7 is baked. The coating film 7 is baked at for example 180° C. Usually, before baking the coating film 7, pre-baking is performed at a lower temperature to volatilize the solvent. The pre-baking and baking are performed on the same hot plate 6 by changing the temperature of the same hot plate 6 or are performed by conveying the substrate 1 on different hot plates 6 kept at different temperatures.

The coating solution containing a polyimide is coated and baked in this way to form a liquid crystal alignment film on a substrate.

Summarizing the problem to be solved by the invention, when the coating solution of the above conventional composition is coated and pre-baked on the hot plate 6 as shown in FIG. 3, due to a slight uneveness of heating or other influences, the rate of volatilization of the solvent does not become uniform on the substrate 1. The boiling point of the γ-butyrolactone used as the main solvent in the coating solution is 204° C., while the boiling point of the N-methyl-α-pyrrolidone used in the same way as the main solvent is 202° C. On the other hand, the boiling point of butyl β-hydroxyethyl ether which is mixed with the main solvent as a leveling agent is 171 to 172° C. The main solvent and butyl β-hydroxyethyl ether are different in boiling points, but these boiling points are close to the baking temperature of the liquid crystal alignment film (about 180° C.) described above.

Therefore, if the rate of volatilization of the solvent varies, the contents of the main solvent and leveling agent in the mixed solvent fluctuate depending on the position. Due to this, as shown in FIG. 4, after pre-baking the liquid crystal alignment film 8, a line-shaped drying mark 9 may remain at the boundary between regions different in the rate of volatilization of the solvent etc.

If a line-shaped drying mark 9 appears on the liquid crystal alignment film 8 due to pre-baking, the drying mark 9 will not disappear even if, as shown in FIG. 1, the liquid crystal alignment film 8 is rubbed after that for aligning the polyimide. A pair of substrates are stacked and liquid crystal material is filled between the substrates in the state with the line-shaped drying mark 9 remaining.

Due to this, the liquid crystal is oriented so that the long axis direction forms a predetermined angle (pretilt angle) with the substrate surface, but at the drying mark 9 part, as shown in FIG. 5, alignment defects 10 of the liquid crystal frequently occur. These alignment defects 10 of the liquid crystal cause a decrease of contrast and/or occurrence of image retention and degrade the display characteristics of the liquid crystal display device.

The pretilt angle of a liquid crystal is controlled by changing the material of the polyimide film or the forming film conditions such as the baking temperature. The above drying mark 9 of the liquid crystal alignment film 8 often occurs particularly when a liquid crystal alignment film is formed for obtaining high pretilt angle. Previously, the pretilt angle of for example a liquid crystal display device of a twisted nematic (TN) mode was about 1 to 2°. Along with the improving resolution of liquid crystal display devices, in the case of a super twisted nematic (STN) mode liquid crystal display device, a pretilt angle may be raised up to about 15°. Therefore, it is important to prevent uneven drying of a liquid crystal alignment film for preventing alignment defects of the liquid crystal.

As a method of improving uneven display and pixel defects of a liquid crystal display device, the method of producing a liquid crystal display element disclosed in Japanese Unexamined Patent Publication (Kokai) No. 8-50293 or No. 11-64812 can be mentioned. In these methods, fine particles mixed in or adhered to a liquid crystal alignment film are removed by focusing soft X-rays to decrease uneven display or pixel defects due to particles.

The method of producing a liquid crystal display element described in Japanese Unexamined Patent Publication (Kokai) No. 8-50293 is characterized in that soft X-rays are focused on the liquid crystal alignment film after rubbing the liquid crystal alignment film.

On the other hand, according to the method of producing a liquid crystal display element described in Japanese Unexamined Patent Publication (Kokai) No. 11-64812, soft X-rays are focused before the rubbing.

In addition, a liquid crystal alignment film or liquid crystal alignment film composition able to decrease uneven display of a liquid crystal display device are disclosed. The liquid crystal alignment film described in Japanese Unexamined Patent Publication (Kokai) No. 7-281192 is characterized by using a polyimide synthesized from six or more amine components and acid components.

The liquid crystal alignment film composition described in Japanese Unexamined Patent Publication (Kokai) No. 8-6030 is characterized by comprising a polymer obtained by reaction of a diamine compound expressed by an ortho-ortho type structure and a carboxylic acid.

The liquid crystal alignment film composition described in Japanese Unexamined Patent Publication (Kokai) No. 9-160046 is characterized by comprising a polymer of ortho-diamine wherein a binding group not containing a polar group is comprised between aromatic rings and a tetracarboxylic acid and/or its derivatives.

The liquid crystal alignment film composition described in Japanese Unexamined Patent Publication (Kokai) No. 10-292113 is characterized by comprising a polymer of an asymmetric carbon diamine and carboxylic acid or its derivative wherein the diamine has one or more alkyl groups of 10 to 19 carbons as a side chain.

As explained above, the liquid crystal alignment film or liquid crystal alignment film composition proposed previously for the purpose of decreasing uneven display of a liquid crystal display device all related to the polymer components of the liquid crystal alignment film.

### SUMMARY OF THE INVENTION

An object of the present invention is to provide a method of forming a liquid crystal alignment film able to prevent uneven drying of a liquid crystal alignment film and thereby prevent alignment defects of the liquid crystal and reduce the defect rate of liquid crystal display devices.

Another object of the present invention is to provide a method of producing a liquid crystal display device able to prevent uneven drying of a liquid crystal alignment film and thereby prevent alignment defects of the liquid crystal and reduce the defect rate of liquid crystal display devices.

According to a first aspect of the present invention, there is provided a method of forming a liquid crystal alignment film comprising the steps of: dissolving a polymer material in a mixed solvent comprising a polar main solvent and a leveling agent and coating the solution on a substrate; pre-baking the substrate to volatilize at least a part of the mixed solvent; and baking the substrate at a higher temperature than the pre-baking to polymerize the polymer material and form a liquid crystal alignment film, wherein a ratio of the leveling agent in the mixed solvent is a predetermined ratio by which the mixed solvent uniformly volatilizes on the substrate during the pre-baking step.

Preferably, the leveling agent comprises butyl β-hydroxyethyl ether.

Preferably, an upper limit of the predetermined ratio is about 15 wt %. Preferably, a lower limit of the predetermined ratio is about 5 wt %.

Preferably, the main solvent is γ-butyrolactone or N-methyl-α-pyrrolidone (NMP).

Preferably, the step of dissolving a polymer material in a mixed solvent and coating the substrate on a substrate comprises a printing step.

Due to this, when the solvent is volatilized by pre-baking after coating the liquid crystal alignment film, the appearance of a line-shaped drying marks in the liquid crystal alignment film can be prevented. Therefore, it becomes possible to prevent alignment defects of the liquid crystal arranged on the liquid crystal film and decrease uneven display of a liquid crystal display device.

According to a second aspect of the present invention, there is provided a method of producing a liquid crystal display device comprising the steps of forming an electrode and a semiconductor element on a substrate; dissolving a polymer material in a mixed solvent comprising a polar main solvent and a leveling agent and coating the substrate on a substrate; pre-baking the substrate to volatilize at least a part of the mixed solvent; baking the substrate at a higher temperature than the pre-baking to polymerize the polymer material and form a liquid crystal alignment film; rubbing the liquid crystal alignment film; and stacking a pair of substrates and filling a liquid crystal material between the substrates, wherein a ratio of the leveling agent in the mixed solvent is a predetermined ratio by which the mixed solvent uniformly volatilizes on the substrate during the pre-baking step.

Preferably, the leveling agent comprises butyl β-hydroxyethyl ether.

Preferably, an upper limit of the predetermined ratio is about 15 wt %. Preferably, a lower limit of the predetermined ratio is about 5 wt %.

Preferably, the main solvent is γ-butyrolactone or N-methyl-α-pyrrolidone (NMP).

Preferably, the step of dissolving a polymer material in a mixed solvent and coating the solution on a substrate comprises a printing step.

Due to this, it becomes possible to prevent appearance of line-shaped drying marks in the liquid crystal alignment film. Therefore, it is possible to prevent alignment defects of the liquid crystal arranged on the liquid crystal alignment film. According to the method of producing a liquid crystal display device of the present invention, since alignment defects of the liquid crystal can be prevented, it becomes possible to produce a liquid crystal display device decreased in uneven display.

### BRIEF DESCRIPTION OF THE DRAWINGS

These and other objects and features of the present invention will become clearer from the following description of the preferred embodiments given with reference to the accompanying drawings, in which:

FIG. 1 is a flow chart showing production steps of a method of producing a liquid crystal display device of the present invention and related art;

FIG. 2 is a schematic view of a coating step of a liquid crystal alignment film in a method of forming a liquid crystal alignment film of the present invention and related art;

FIG. 3 is a schematic view of pre-baking and baking steps in a method of forming a liquid crystal alignment film of the present invention and related art;

FIG. 4 is a view of a line-shaped drying mark appearing in a liquid crystal alignment film according to a conventional method of forming a liquid crystal alignment film; and

FIG. 5 is a view of uneven display of a liquid crystal display device caused by the line-shaped drying mark shown in FIG. 4.

### DESCRIPTION OF THE PREFERRED EMBODIMENTS

Below, preferred embodiments of a method of forming a liquid crystal alignment film and a method of producing a liquid crystal display device of the present invention will be described with reference to the accompanying drawings.

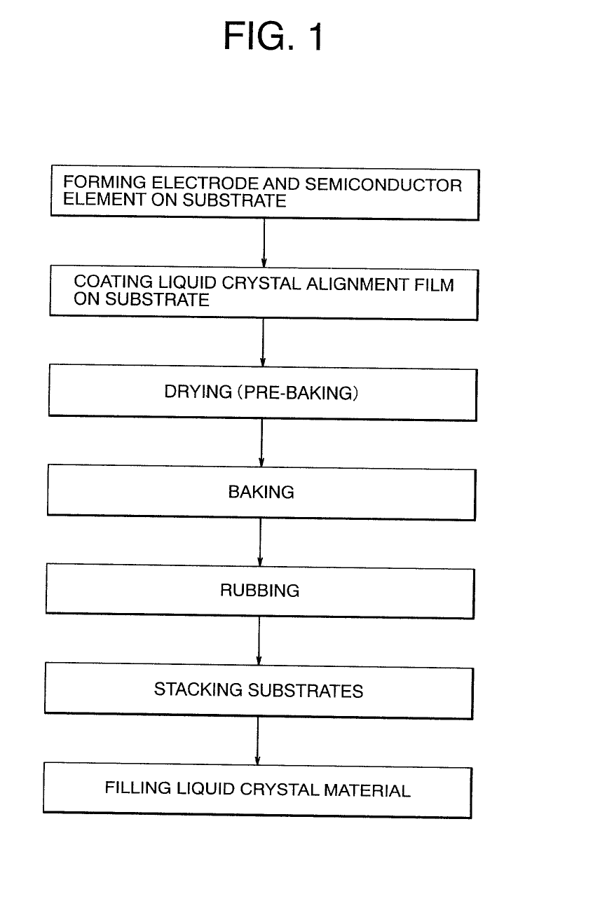

FIG. 1 is a flow chart of main production steps of a method of producing a liquid crystal display device of the present embodiment.

As shown in FIG. 1, first, electrodes and semiconductor elements are formed on a substrate. Next, a liquid crystal alignment film is coated on the substrate. Here, as explained later, a solvent containing 5 to 15 wt % of butyl β-hydroxyethyl ether as a leveling agent is used. The liquid crystal alignment film is baked, then the liquid crystal alignment film is rubbed. After this, substrates are stacked and a liquid crystal material is filled between the substrates to orient the liquid crystal molecules on the liquid crystal alignment film.

In the method of forming a liquid crystal alignment film and a liquid crystal display device of the present embodiment, a polyimide is used as the polymer material comprising the liquid crystal alignment film. A polyimide has the following characteristics required for a liquid crystal alignment film: (1) a high heat resistance (300° C.); (2) transparency and a high glass transition temperature T_{g}; (3) an affinity with liquid crystal, an ease of alignment of liquid crystal, and non-reactivity with liquid crystal; (4) high bondability with the substrate and electrodes; and (5) simple alignment treatment.

A polyimide is obtained by heat polymerization of polyamic acid (polyimide acid) at 250° C. or a higher temperature. However, there are limits to the heat resistance of other parts of a liquid crystal display device such as a color filter formed on a semiconductor element, so a liquid crystal alignment film is often formed by coating and baking a soluble polyimide prepared by imidazation of polyamic acid and dissolved in a solvent. In this case, it is possible to bake a polyimide film at up to 180° C.

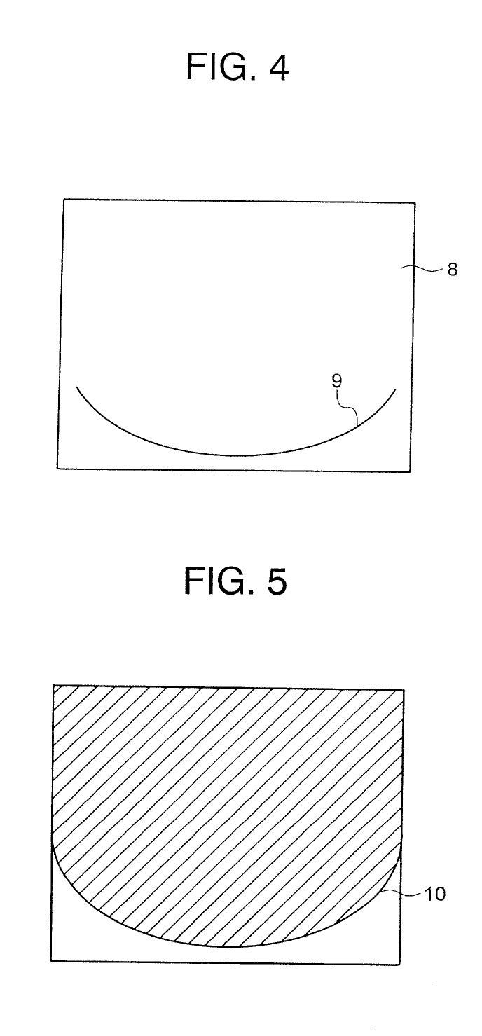

For the coating solution of the liquid crystal alignment film, for solubilizing the imide component, for example γ-butyrolactone, N-methyl-α-pyrrolidone (NMP), or another polar solvent is used as a main solvent. Further, for improving the coating characteristics and leveling characteristics after coating, about 5 to 15 wt % of butyl β-hydroxyethyl ether is added to the main solvent. Due to this, the mixed solvent can be volatilized uniformly on the substrate during pre-baking. Therefore, it becomes possible to prevent occurrence of a line-shaped drying mark 9 as shown in FIG. 4.

When the ratio of butyl β-hydroxyethyl ether in the mixed solvent is over about 15 wt %, due to the difference in the boiling points between the main solvent γ-butyrolactone (boiling point 204° C.) or N-methyl-α-pyrrolidone (NMP) (boiling point 202° C.) and the leveling agent butyl β-hydroxyethyl ether (boiling point 171 to 172° C.) or other influences, the ratio of the main solvent and leveling agent becomes uneven on the substrate. Due to this, a line-shaped drying mark readily appears in the liquid crystal alignment film. On the other hand, when the ratio of butyl β-hydroxyethyl ether in the mixed solvent is about 5 wt % or less, the coating characteristics of the coating solution or leveling characteristics of the liquid crystal alignment film after coating become insufficient.

Due to the above reason, the ratio of butyl β-hydroxyethyl ether is preferably about 5 to 15 wt %.

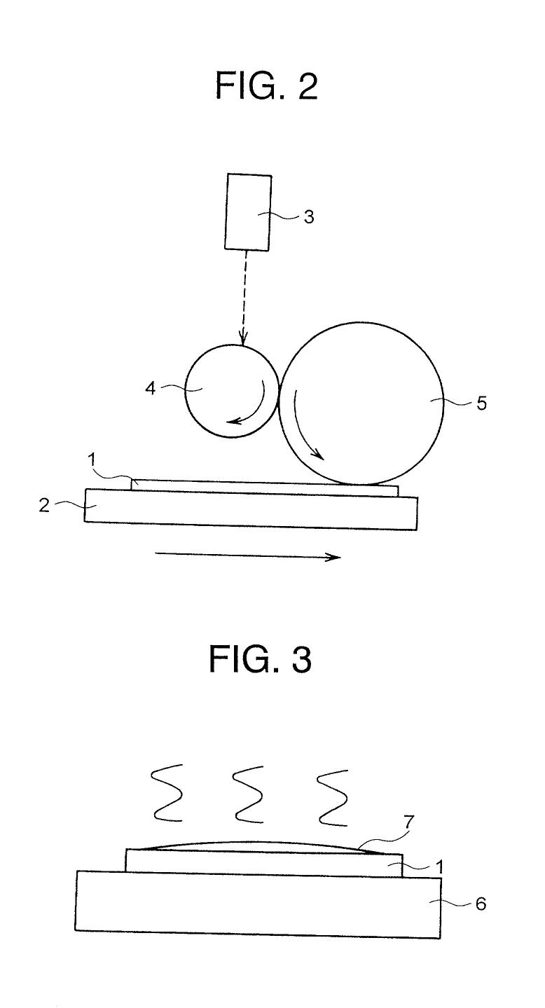

A coating solution of a liquid crystal alignment film is coated by a printing method using a roll coater on a substrate to a thickness of for example about 50 to 100 nm. FIG. 2 is a schematic view of a roll coater for coating a liquid crystal alignment film. As shown in FIG. 2, a substrate 1 is conveyed carried on a table 2. A coating solution is supplied from a dispenser 3 to an anilox roller 4. The coating solution supplied to the anilox roller 4 is transferred to a plate cylinder 5 to a uniform thickness. Then, the coating solution is coated uniformly on the substrate 1 by the plate cylinder 5.

The surface of the anilox roller 4 is engraved. The thickness of the coating film changes depend on the number of engraved lines and the depth or shape of the engraving. The thickness of the coating film is also controlled by a supply rate of the coating solution from the dispenser 3 or adjustment of pressure between the anilox roller 4 and plate cylinder 5.

After coating the liquid crystal alignment film, as shown in FIG. 3, the substrate 1 is conveyed to a hot plate 6 and the coating film 7 is baked. The coating film 7 is baked at for example 180° C. Usually, before baking the coating film 7, pre-baking is performed at a lower temperature to volatilize the solvent. The pre-baking and baking are performed on the same hot plate 6 by changing the temperature of the same hot plate 6 or are performed by conveying the substrate 1 on different hot plates 6 kept at different temperatures.

The coating solution containing a polyimide is coated and baked in this way to form a liquid crystal alignment film on a substrate.

According to the method of forming a liquid crystal alignment film and a method of producing a liquid crystal display device of the above present embodiment, since occurrence of a drying mark of the liquid crystal alignment film is prevented, it becomes possible to orient the liquid crystal on the liquid crystal alignment film at a predetermined pretilt angle. Due to this, it becomes possible to prevent a decrease of contrast caused by alignment defects of the liquid crystal and occurrence of image retention etc. and to improve display characteristics of a liquid crystal display device.

Note that the present invention is not limited to the above embodiments and includes modifications within the scope of the claims. For example, it is also possible to coat the liquid crystal alignment film by spin-coating if the composition of the mixed solvent is suitably modified within the range where a line-shaped drying mark does not appear in the liquid crystal alignment film.

According to the method of forming a liquid crystal alignment film of the present invention, it becomes possible to prevent occurrence of a line-shaped drying mark during pre-baking of a liquid crystal alignment film which causes alignment defects of the liquid crystal.

According to the method of producing a liquid crystal display device of the present invention, it becomes possible to prevent occurrence of a line-shaped drying mark in a liquid crystal alignment film and orient the liquid crystal molecules at a predetermined pretilt angle to eliminate pixel defects of a liquid crystal display device.

While the invention has been described with reference to specific embodiments chosen for purpose of illustration, it should be apparent that numerous modifications could be made thereto by those skilled in the art without departing from the basic concept and scope of the invention.

What is claimed is:

1. A method of forming a liquid crystal alignment film comprising the steps of:
dissolving a polymer material in a mixed solvent comprising a polar main solvent and a leveling agent and coating the solution on a substrate;
pre-baking the substrate to volatilize at least a part of the mixed solvent; and
baking the substrate at a higher temperature than the pre-baking to polymerize the polymer material and form a liquid crystal alignment film,
wherein a ratio of the leveling agent in the mixed solvent is a predetermined ratio by which the mixed solvent uniformly volatilizes on the substrate during the pre-baking step.

2. A method of forming a liquid crystal alignment film as set forth in claim 1, wherein the leveling agent comprises butyl β-hydroxyethyl ether.

3. A method of forming a liquid crystal alignment film as set forth in claim 2, wherein an upper limit of the predetermined ratio is about 15 wt %.

4. A method of forming a liquid crystal alignment film as set forth in claim 3, wherein a lower limit of the predetermined ratio is about 5 wt %.

5. A method of forming a liquid crystal alignment film as set forth in claim 4, wherein the main solvent is γ-butyrolactone.

6. A method of forming a liquid crystal alignment film as set forth in claim 4, wherein the main solvent is N-methyl-α-pyrrolidone (NMP).

7. A method of forming a liquid crystal alignment film as set forth in claim 4, wherein the step of dissolving a polymer material in a mixed solvent and coating the solution on a substrate comprises a printing step.

8. A method of producing a liquid crystal display device comprising the steps of:
forming an electrode and a semiconductor element on a substrate;
dissolving a polymer material in a mixed solvent comprising a polar main solvent and a leveling agent and coating the solution on a substrate;
pre-baking the substrate to volatilize at least part of the mixed solvent;
baking the substrate at a higher temperature than the pre-baking to polymerize the polymer material and form a liquid crystal alignment film;
rubbing the liquid crystal alignment film; and
stacking a pair of substrates and filling a liquid crystal material between the substrates,
wherein a ratio of the leveling agent in the @mixed solvent is a predetermined ratio by which the mixed solvent uniformly volatilizes on the substrate during the pre-baking step.

9. A method of forming a liquid crystal alignment film as set forth in claim 8, wherein the leveling agent comprises butyl β-hydroxyethyl ether.

10. A method of forming a liquid crystal alignment film as set forth in claim 9, wherein an upper limit of the predetermined ratio is about 15 wt %.

11. A method of forming a liquid crystal alignment film as set forth in claim 10, wherein a lower limit of the predetermined ratio is about 5 wt %.

12. A method of forming a liquid crystal alignment film as set forth in claim 11, wherein the main solvent is γ-butyrolactone.

13. A method of forming a liquid crystal alignment film as set forth in claim 11, wherein the main solvent is N-methyl-α-pyrrolidone (NMP).

14. A method of forming a liquid crystal alignment film as set forth in claim 11, wherein the step of dissolving a polymer material in a mixed solvent and coating the solution on a substrate comprises a printing step.
